(19) United States
(12) Patent Application Publication
(10) Pub. No.: US 2025/0079918 A1
(43) Pub. Date: Mar. 6, 2025

(54) HAIRPIN COIL COOLING STRUCTURE FOR HAIRPIN WINDING MOTOR

(71) Applicant: HYUNDAI MOBIS CO., LTD., Seoul (KR)

(72) Inventors: Eui Sung YOO, Gwangju-si (KR); Hyun Ho PARK, Suwon-si (KR)

(73) Assignee: HYUNDAI MOBIS CO., LTD., Seoul (KR)

(21) Appl. No.: 18/770,941

(22) Filed: Jul. 12, 2024

(30) Foreign Application Priority Data
Sep. 5, 2023 (KR) 10-2023-0117930

(51) Int. Cl. H02K 1/32; H02K 3/24

(52) U.S. Cl. CPC H02K 1/32; H02K 3/24; H02K 2203/09

(57) ABSTRACT

The present invention relates to a cooling structure for a hairpin winding motor, and more particularly, to a hairpin coil cooling structure for a hairpin winding motor, which is capable of improving performance in cooling a hairpin coil by spraying oil to a rotor plate, which is a component of a motor, and dispersing the cooling oil by rotating the rotor plate.

### CROSS REFERENCE TO RELATED APPLICATION

The present application claims priority to Korean Patent Application No. 10-2023-0117930, filed on Sep. 5, 2023, the entire contents of which are incorporated herein for all purposes by this reference.

### BACKGROUND OF THE INVENTION

### Field of the Invention

The present invention relates to a cooling structure for a hairpin winding motor, and more particularly, to a hairpin coil cooling structure for a hairpin winding motor, which is capable of improving performance in cooling a hairpin coil by spraying oil to a rotor plate, which is a component of a motor, and dispersing the cooling oil by rotating the rotor plate.

### Description of the Related Art

Recently, studies have been actively conducted to improve an output of a motor that is a key component of a hybrid or electric vehicle.

In general, it is known that the output of the motor is proportional to the number of turns of a coil wound around a stator core. Therefore, a method of increasing a space factor of the coil wound around the stator core may be considered to improve the output of the motor without increasing a size of the motor.

Recently, as an example of the method, a method of winding an angular coil (flat coil) having an approximately quadrangular cross-sectional shape instead of using an annular coil having a circular cross-section has been studied.

However, it is more difficult to perform an operation of winding the angular coil than an operation of winding the annular coil. Therefore, as a way to make it easy to wind the angular coil, a motor (hereinafter, referred to as a ‘hairpin winding motor’) has been proposed, in which a plurality of separated hairpins is inserted and fastened into a stator coil, and then the hairpins are joined by welding to define a coil winding part.

FIG. 1 illustrates a general hairpin winding motor 10, and FIG. 2 is a cross-sectional view illustrating the general hairpin winding motor 10. In the illustrated hairpin winding motor 10, a coil winding part of a stator core 12 is formed by fastening hairpin coils 13, which are formed in an approximately ‘U’ or ‘V’ shape, into slots of the stator core 12 disposed inside a housing 11 and then joining and welding the hairpin coils 13 disposed on layers of the slots. Therefore, the hairpin winding motor 10 facilitates the operation of winding the angular coil while overcoming mechanical limitations caused by a winding machine.

Meanwhile, the housing 11 further includes an oil injection tube 15 through which cooling oil is supplied into the housing 11 to cool the hairpin winding motor 10 that generates heat.

In the cooling structure for the hairpin winding motor 10 in the related art, the cooling oil introduced into the housing 11 flows, as indicated by the arrows, because of rotor plates (not illustrated) disposed at one open side 12a and the other open side 12b of the stator core 12, and the cooling oil is supplied and circulated only to a radially outer side of the hairpin coil 13, which causes a problem of deterioration in performance in cooling the coil disposed radially inward.

In particular, there is a need to develop a technology to prevent deterioration in performance caused by an increase in temperature of the hairpin coil because the cooling method is biased to the radially outer side even though a large amount of heat is generated from a radially inner side of the hairpin coil adjacent to the rotor.

### SUMMARY OF THE INVENTION

The present invention is proposed to solve these problems and aims to provide a hairpin coil cooling structure for a hairpin winding motor, which is capable of improving performance in cooling a radially inner coil, among hairpin coils, adjacent to a rotor that generates the largest amount of heat in the motor.

The present invention also aims to provide a hairpin coil cooling structure for a hairpin winding motor, which is capable of spraying cooling oil to a rotor plate and rotating the rotor plate so that the cooling oil dispersed by a rotation of the rotor plate is sprayed to an inner coil.

An embodiment of the present invention provides a hairpin coil cooling structure for a hairpin winding motor including a stator having a plurality of slots formed through the stator in a circumferential direction thereof and each having a plurality of layers in a radial direction thereof, and a plurality of hairpin coils fastened to the slots and connected to one another to define a coil winding, in which the winding motor includes: a rotor rotatably mounted inside the stator; a rotor shaft connected to the rotor; a pair of rotor plates respectively provided at a first end portion and a second end portion of the rotor shaft and configured to cover a first open side and a second open side of the stator; and an oil injection tube configured to spray a cooling oil into the winding motor, in which a nozzle, which is provided at an end of the cooling oil injection tube to spray the cooling oil to an outer surface of the rotor plate, is disposed to be directed toward the outer surface of the rotor plate, and in which the cooling oil sprayed to the outer surface of the rotor plate is scattered toward an inner coil, which is positioned at a radially inner side of the stator among the hairpin coils, by a rotation of the rotor plate.

In addition, the rotor plate may include: a circular body portion having a center penetrated by the rotor shaft; a spray portion protruding outward from an outer surface of the circular body portion, formed at a radially center of the circular body portion, and formed in a circumferential direction thereof; a spray groove formed in a radially inner surface of the spray portion and recessed radially outward; and a spray hole formed in the spray groove and formed through the radially inner surface and an outer surface of the spray portion, a spray surface configured to spray the cooling oil may be formed on the outer surface of the circular body portion, and the spray surface may be formed at a radially inner side of the spray portion.

In addition, the cooling oil injection tube may further include an auxiliary nozzle formed on the cooling oil injection tube and directed toward the inner coil to spray the supplied cooling oil directly to the inner coil.

In addition, the rotor plate may include: a circular body portion having a center penetrated by the rotor shaft; a spray portion protruding outward from an outer surface of the circular body portion, formed at a radially center of the circular body portion, and formed in a circumferential direction thereof; a first spray groove formed in a radially inner surface of the spray portion, disposed adjacent to the outer surface of the circular body portion, and recessed radially outward; a second spray groove formed in the radially inner surface of the spray portion, disposed to be spaced apart from the outer surface of the circular body portion, and recessed radially outward; a spray hole formed in the second spray groove and formed through the radially inner surface and an outer surface of the spray portion; a partition wall formed to separate the first spray groove and the second spray groove; and connection grooves formed in the partition wall so that the cooling oil distributed in the first spray groove moves to the second spray groove, a spray surface configured to spray the cooling oil may be formed on the outer surface of the circular body portion, and the spray surface may be formed at a radially inner side of the spray portion.

In addition, the connection grooves may be formed at predetermined distances in the circumferential direction and recessed radially inward, the connection groove may be formed adjacent to the spray hole, and a depth of the connection groove may be smaller than a depth of each of the first and second spray grooves.

In addition, the spray hole may be disposed to be spaced apart from a position, at which the connection groove is formed, by a first angle θ in a direction opposite to the rotation of the rotor plate.

In addition, the connection groove may be inclined at a second angle a with respect to a rotation axis of the rotor plate in a rotation direction of the rotor plate.

In addition, the cooling oil injection tube may be connected to a lubricating oil spray tube configured to inject lubricating oil into the winding motor, and the cooling oil may be the lubricating oil.

In addition, the spray hole may be provided as a plurality of spray holes disposed to be spaced apart from one another in the circumferential direction of the spray portion.

Further, the auxiliary nozzle may be provided as a plurality of auxiliary nozzles disposed to be spaced apart from one another in a longitudinal direction of the cooling oil injection tube.

### BRIEF DESCRIPTION OF THE DRAWINGS

FIG. 1 is a perspective view of a general hairpin winding motor.

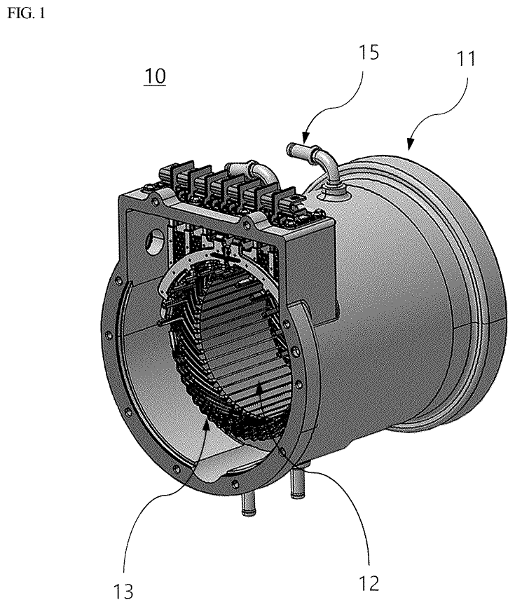

FIG. 2 is a cross-sectional view of the general hairpin winding motor.

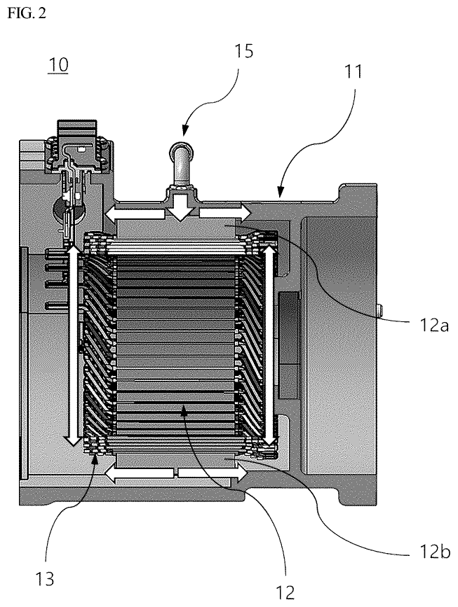

FIG. 3 is a front perspective view of a hairpin winding motor according to an embodiment of the present invention.

FIG. 4 is a rear perspective view of the hairpin winding motor according to the embodiment of the present invention.

FIG. 5 is a partially enlarged perspective view of the hairpin winding motor according to the embodiment of the present invention.

FIG. 6 is a perspective view and a cross-sectional inner side view of a rotor plate according to a first embodiment of the present invention.

FIG. 7 is a partially enlarged perspective view of a hairpin winding motor according to another embodiment of the present invention.

FIG. 8 is a perspective view illustrating an oil injection tube according to another embodiment of the present invention.

FIG. 9 is a perspective view and a cross-sectional inner side view of a rotor plate according to a second embodiment of the present invention.

FIG. 10 is a partially enlarged perspective view illustrating an oil flow path of the rotor plate according to the second embodiment of the present invention.

FIG. 11 is a partially enlarged front view of a rotor plate according to a third embodiment of the present invention.

FIG. 12 is a partially enlarged perspective view of a rotor plate according to a fourth embodiment of the present invention.

FIG. 13 is a partially enlarged perspective view of a hairpin winding motor according to a fifth embodiment of the present invention.

FIG. 14 is a view illustrating performance in cooling the hairpin winding motor according to the embodiment of the present invention.

### DETAILED DESCRIPTION OF THE INVENTION

Hereinafter, the embodiments of the present invention will be described in detail with reference to the drawings.

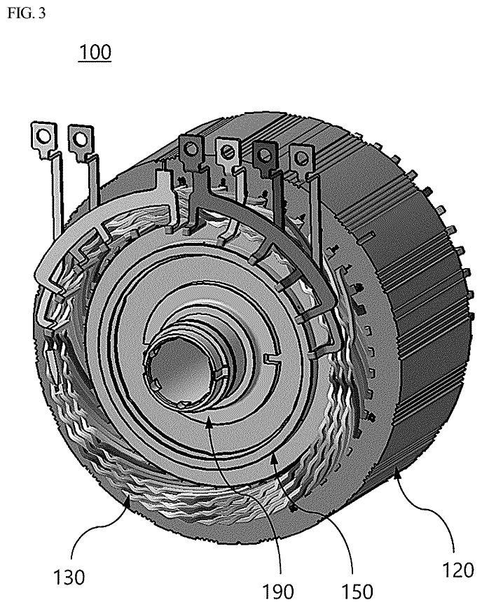

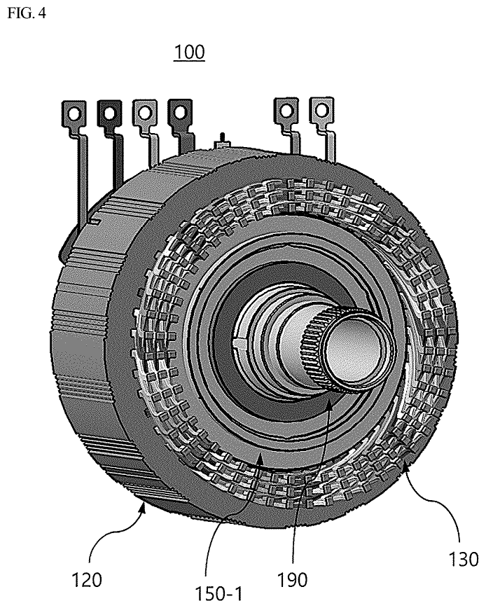

FIG. 3 is a front perspective view of a hairpin winding motor 100 according to an embodiment of the present invention, and FIG. 4 is a rear perspective view of the hairpin winding motor 100 according to the embodiment of the present invention.

In the illustrated hairpin winding motor 100, a coil winding part of a stator 120 is formed by fastening hairpin coils 130, which are formed in an approximately ‘U’ or ‘V’ shape, into slots of the stator 120 and then joining and welding the hairpin coils 130 disposed on layers of the slots.

Meanwhile, a rotor (not illustrated) is rotatably mounted inside the stator 120. A rotor shaft 190 is connected to the rotor. A rotor plate 150 is provided at one end of the rotor shaft 190 and covers one open side of the stator 120. A rotor plate 150-1 is provided at the other end of the rotor shaft 190 and covers the other open side of the stator 120.

In this case, the present invention is characterized in that a part of oil introduced into the hairpin winding motor 100 is scattered toward a radially inner side of the hairpin coil 130 by the rotor plate 150 that rotates in conjunction with the rotor shaft 190. A detailed configuration of the hairpin winding motor 100 for implementing the above-mentioned characteristics will be described in detail with reference to the drawings.

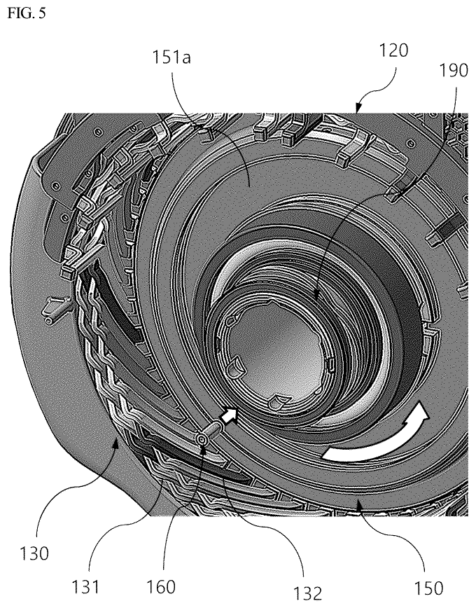

FIG. 5 is a partially enlarged perspective view of the hairpin winding motor 100 according to the embodiment of the present invention.

As illustrated in FIG. 5, the rotor plate 150 is provided at one open side of the stator 120 and coupled to the rotor shaft 190. In addition, the winding motor 100 includes an oil injection tube 160 configured to supply cooling oil into the winding motor 100. The cooling oil injection tube 160 has a nozzle formed at an end thereof to supply (spray) the cooling oil to one surface 151a of the rotor plate 150, and the nozzle is disposed to be directed toward one surface of the rotor plate 150.

In this case, the following configuration is provided to supply the oil, which is supplied to one surface 151a of the rotor plate 150, to an inner coil 132 positioned at a radially inner side among the hairpin coils 130.

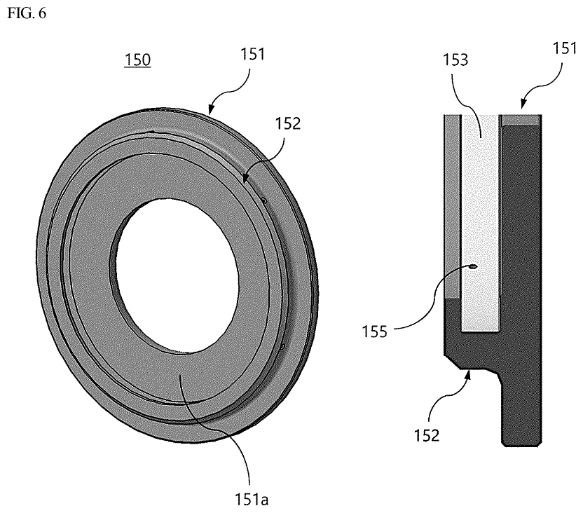

FIG. 6 is a perspective view and a cross-sectional inner side view of the rotor plate 150 according to a first embodiment of the present invention.

As illustrated, the rotor plate 150 includes a circular plate-shaped body portion 151 having a hollow portion formed at a center thereof so that the rotor shaft penetrates the circular body portion 151, and a spray portion 152 protruding from one surface of the circular body portion 151 toward one side. The spray portion 152 is formed on a radially central portion of the circular body portion 151 and formed in a circumferential direction. A spray groove 153 is formed in a radially inner surface of the spray portion 152 and recessed radially outward, and the spray groove 153 is also formed in the circumferential direction. In addition, spray holes 155 are formed in the spray groove 153 and formed through the radially inner surface and an outer surface of the spray portion 152. The spray holes 155 may be provided as a plurality of spray holes 155 disposed to be spaced apart from one another in the circumferential direction.

Meanwhile, a spray surface 151a is formed on one surface of the circular body portion 151, and the spray surface 151a may be formed at a radially inner side of the spray portion 152.

Therefore, when the rotor plate 150 rotates, the cooling oil supplied to the spray surface 151a through the cooling oil injection tube 160 is distributed in the circumferential direction on the spray groove 153 of the spray portion 152 by a centrifugal force, and the cooling oil is sprayed in the circumferential direction toward a radially outer side of the spray portion 152 through the spray holes 155. Meanwhile, because the inner coils 132 positioned at the radially inner side among the hairpin coils 130 are disposed adjacent to the outer side of the rotor plate 150, the sprayed oil may be scattered toward the inner coils 132.

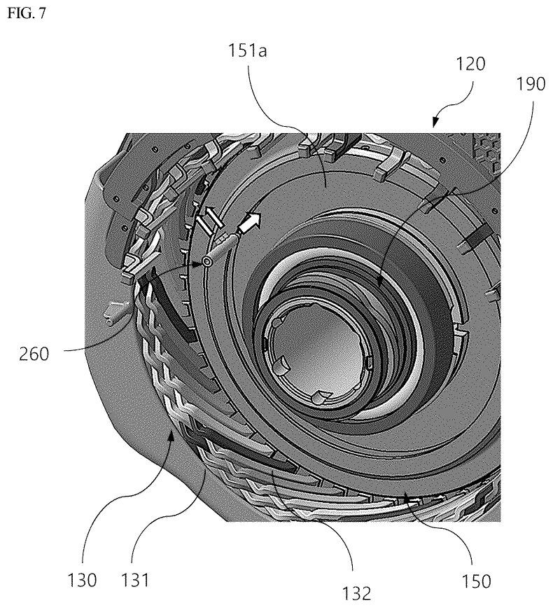

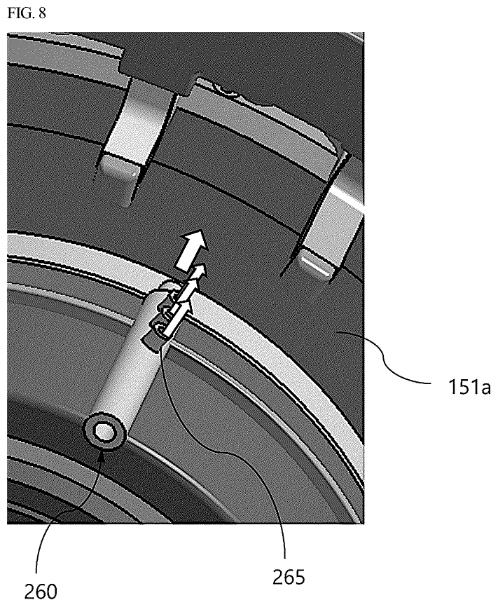

FIG. 7 is a partially enlarged perspective view of the hairpin winding motor having an oil injection tube 260 according to another embodiment of the present invention. In addition, FIG. 8 is a perspective view illustrating the cooling oil injection tube 260 according to another embodiment of the present invention.

The rotor plate 150 is provided at one open side of the stator 120 and coupled to the rotor shaft 190. In addition, the winding motor 100 includes the cooling oil injection tube 260 configured to supply cooling oil into the winding motor 100. The cooling oil injection tube 260 has a nozzle formed at an end thereof to supply (spray) the cooling oil to one surface 151a of the rotor plate 150, and the nozzle is disposed to be directed toward one surface of the rotor plate 150. In this case, the cooling oil injection tube 260 according to another embodiment of the present invention has the following configuration to spray the supplied cooling oil directly to the inner coil 132 positioned at the radially inner side among the hairpin coils 130.

Auxiliary nozzles 265 may be further provided on the cooling oil injection tube 260, and the auxiliary nozzles 265 are disposed toward the inner coil 132 positioned at the radially inner side among the hairpin coils 130. In addition, the auxiliary nozzles 265 may be provided as a plurality of auxiliary nozzles 265 disposed to be spaced apart from one another in a longitudinal direction of the cooling oil injection tube 260. Therefore, in the present embodiment, the cooling oil may be scattered toward the inner coil 132 by the rotor plate 150, and at the same time, the cooling oil may be sprayed directly to the inner coil 132 through the auxiliary nozzles 265, thereby increasing an area of the cooling oil sprayed to the inner coil 132.

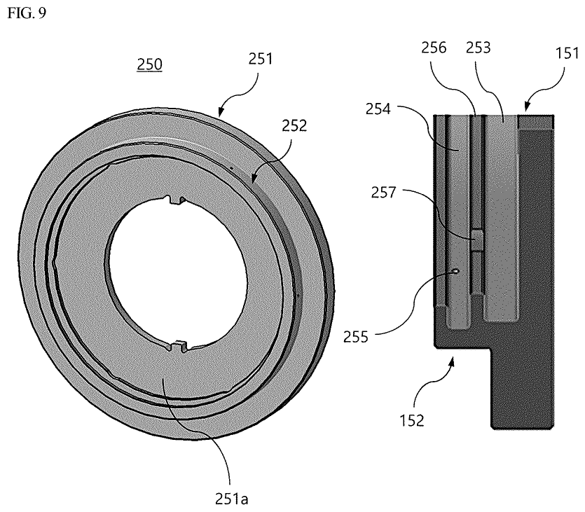

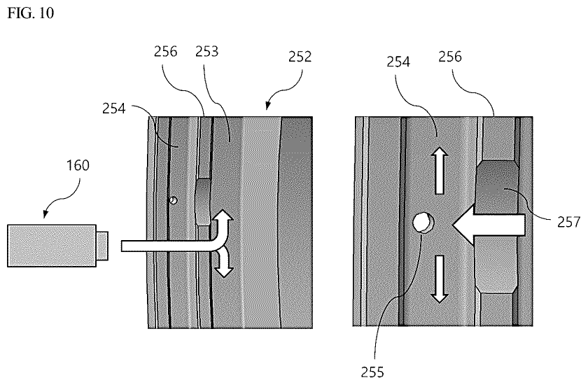

FIG. 9 is a perspective view and a cross-sectional inner side view of a rotor plate 250 according to a second embodiment of the present invention, and FIG. 10 is a partially enlarged perspective view illustrating an oil flow path of the rotor plate 250 according to the second embodiment of the present invention.

As illustrated, the rotor plate 250 includes a circular plate-shaped body portion 251 having a hollow portion formed at a center thereof so that the rotor shaft penetrates the circular body portion 251, and a spray portion 252 protruding from one surface of the circular body portion 151 toward one side. The spray portion 252 is formed on a radially central portion of the circular body portion 251 and formed in the circumferential direction. First and second spray grooves 253 and 254 are formed in a radially inner surface of the spray portion 252 and recessed radially outward, and the first and second spray grooves 253 and 254 are also formed in the circumferential direction. The first spray groove 253 is disposed adjacent to one surface 251a of the circular body portion 251, and the second spray groove 254 is disposed to be spaced apart from one surface 251a. The first spray groove 253 and the second spray groove 254 are separated by a partition wall 256. In addition, spray holes 255 are formed in the second spray groove 254 and formed through the radially inner surface and an outer surface of the spray portion 252. The spray holes 255 may be provided as a plurality of spray holes 255 disposed to be spaced apart from one another in the circumferential direction.

Meanwhile, a spray surface 251a is formed on one surface of the circular body portion 251, and the spray surface 251a may be formed at a radially inner side of the spray portion 252. Therefore, when the rotor plate 250 rotates, the cooling oil supplied to the spray surface 251a through the cooling oil injection tube 160 is distributed in the circumferential direction on the first spray groove 253 of the spray portion 152 by a centrifugal force. In this case, connection grooves 257 may be formed in the partition wall 256 so that the cooling oil may move to the second spray groove 254 when the cooling oil distributed in the first spray groove 253 reaches a predetermined level. The connection grooves 257 may be formed at predetermined distances in the circumferential direction and recessed radially inward. A position of the connection groove 257 may be adjacent to the spray hole 255. In addition, a depth of the connection groove 257 may be smaller than a depth of each of the first and second spray grooves 253 and 254. In case that the cooling oil distributed in the first spray groove 253 reaches a predetermined level, i.e., becomes higher than the connection groove 257, the cooling oil moves to the second spray groove 254 through the connection groove 257, and the cooling oil supplied to the second spray groove 254 is sprayed to the inner coil 132 through the spray hole 255. According to the rotor plate 250 of the second embodiment, in a state in which the cooling oil is distributed uniformly in the circumferential direction of the first spray groove 253, the cooling oil may be moved to the second spray groove 254 through the connection grooves 257 and sprayed through the spray holes 255, such that the cooling oil may be uniformly distributed to the plurality of spray holes 255, thereby further improving efficiency in scattering the oil.

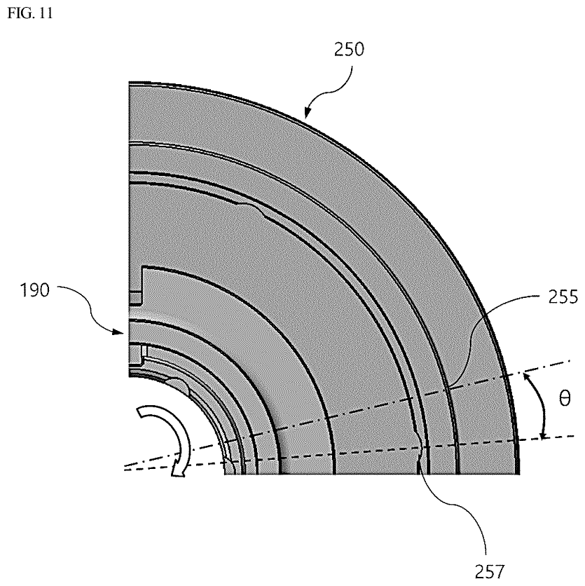

FIG. 11 is a partially enlarged front view of a rotor plate 250 according to a third embodiment of the present invention. As illustrated, the spray hole 255 may be disposed to be spaced apart from the position, at which the connection groove 257 is formed, by a first angle θ in a direction opposite to the rotation of the rotor plate 250.

This is based on the fact that the oil, which accumulates in the first spray groove 253, spirally flows by the rotation of the rotor plate 250 when the cooling oil moves to the second spray groove 254 through the connection groove 257. Therefore, the connection groove 257 and the spray hole 255 may be disposed to be spaced apart from each other by the first angle without being positioned on a straight line in the radial direction. Therefore, the oil, which has moved to the second spray groove 254 through the connection groove 257, may move to the spray hole 255 along the shortest route.

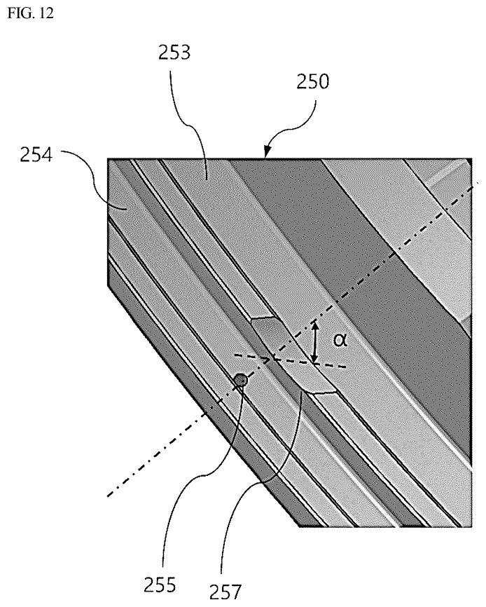

FIG. 12 is a partially enlarged perspective view of a rotor plate 250 according to a fourth embodiment of the present invention.

The connection groove 257 may be inclined at a second angle a with respect to a rotation axis of the rotor plate 250 in consideration of the rotation direction of the rotor plate 250. That is, in consideration of the situation in which the cooling oil spirally flows by the rotation of the rotor plate 250, the connection groove 257 may be formed to correspond to the spiral flow of the oil, thereby improving the flow performance of the oil.

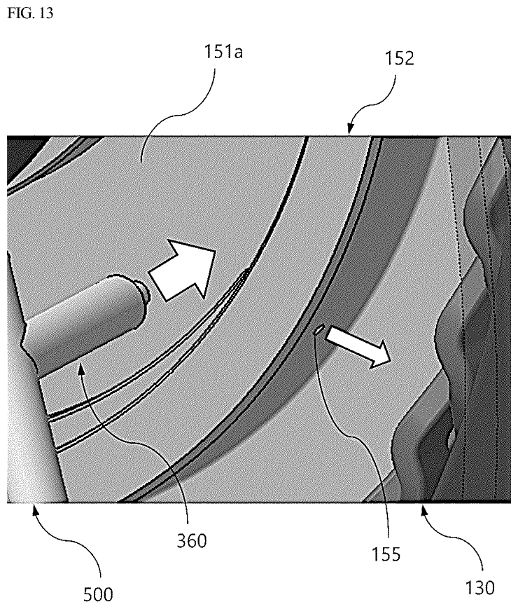

FIG. 13 is a partially enlarged perspective view of a hairpin winding motor 100 according to still another embodiment of the present invention.

An oil injection tube 360 may be connected to a lubricating oil spray tube 500 configured to supply lubricating oil for lubricating a rotor bearing, and the cooling oil injection tube 360 may be configured to spray the lubricating oil to the spray surface 151a of the rotor plate 150. In case that the cooling oil injection tube 360 is connected to a separate tube to directly spray the oil, a load of a pump may be increased by a pressure drop. Therefore, the cooling oil injection tube 360 may be connected to the lubricating oil spray tube 500 for lubricating the rotor bearing, thereby reducing a pressure drop.

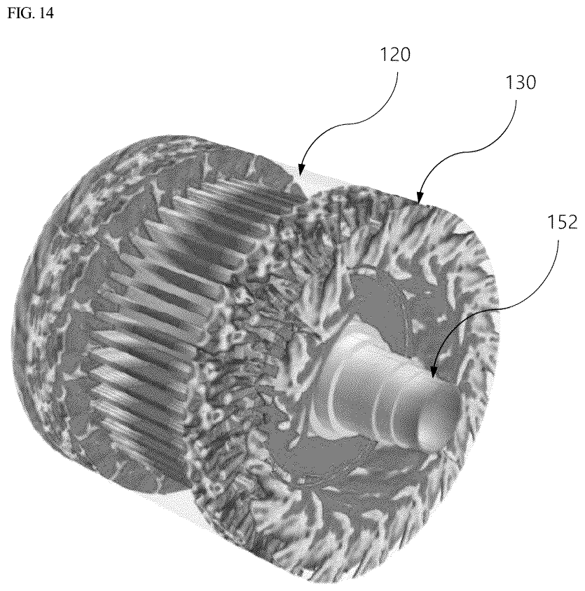

FIG. 14 is a view illustrating performance in cooling the hairpin winding motor 100 according to the embodiment of the present invention. The light color indicates a high temperature, and the deep color indicates a low temperature. As illustrated, it can be seen that in the case of the winding motor 100 of the present invention, the cooling oil is sprayed to the inner coil through the spray holes formed in the rotor plate 150, and the cooling oil is sprayed uniformly to the inner coil by the rotation of the rotor plate 150.

In addition, it can be seen that it is possible to more effectively cool the inner coil, among the hairpin coils, by means of various embodiments such as the sizes of the spray holes, the number of spray grooves, and the like.

According to the hairpin coil cooling structure for a hairpin winding motor of the present invention configured as described above, the performance in cooling the relatively weak inner coil of the hairpin core may be improved, thereby preventing the deterioration in performance of the hairpin winding motor and improving the durability.

In addition, the basic configuration of the hairpin winding motor may be maintained, such that the hairpin coil cooling structure may be applied to a motor in the related art, thereby reducing production costs or time, which may be increased by a change in production facilities, and recycling resources.

The cooling oil scattering flow rate or the cooling oil scattering shape may be easily changed only by changing the shape of the rotor plate, thereby reducing production costs or time that may be increased by a change in layouts of the motor.

The technical spirit should not be construed as being limited to the embodiments of the present invention. Of course, the scope of application is diverse, and various modifications and implementations may be made by those skilled in the art without departing from the subject matter of the present invention claimed in the claims. Accordingly, these improvements and modifications will fall within the scope of the present invention as long as they are apparent to those skilled in the art.

### DESCRIPTION OF REFERENCE NUMERALS

100: Hairpin winding motor
120: Stator
130: Hairpin coil
131: Hairpin outer coil
132: Hairpin inner coil
150, 150-1: Rotor plate
151a: Spray surface
151: Body portion
152: Spray portion
153: Spray groove
155: Spray hole
160, 260: Oil injection tube
265: Auxiliary nozzle
190: Rotor shaft
250: Rotor plate
251: Body portion
252: Spray portion
251a: Spray surface
253: First spray groove
254: Second spray groove
255: Spray hole
256: Partition wall
257: Connection groove
500: Lubricating oil spray tube

What is claimed is:

1. A hairpin winding motor comprising:
A stator having a plurality of slots formed through the stator in a circumferential direction thereof and each having a plurality of layers in a radial direction thereof;
a plurality of hairpin coils fastened to the slots and connected to one another to define a coil winding,
a rotor rotatably mounted inside the stator;
a rotor shaft connected to the rotor;
a pair of rotor plates respectively provided at a first end portion and a second end portion of the rotor shaft and configured to cover a first open side and a second open side of the stator, and
an oil injection tube configured to spray a cooling oil into the winding motor,
wherein a nozzle, which is provided at an end of the cooling oil injection tube to spray the cooling oil to an outer surface of the rotor plate, is disposed to be directed toward the outer surface of the rotor plate, and
wherein the cooling oil sprayed to the outer surface of the rotor plate is scattered toward an inner coil, which is positioned at a radially inner side of the stator among the hairpin coils, by a rotation of the rotor plate.

2. The hairpin winding motor of claim 1, wherein the rotor plate includes:
a circular body portion having a center penetrated by the rotor shaft;
a spray portion protruding outward from an outer surface of the circular body portion, formed at a radially center of the circular body portion, and formed in a circumferential direction thereof;
a spray groove formed in a radially inner surface of the spray portion and recessed radially outward; and
a spray hole formed in the spray groove and formed through the radially inner surface and an outer surface of the spray portion, and
wherein a spray surface configured to spray the cooling oil is formed on the outer surface of the circular body portion, and the spray surface is formed at a radially inner side of the spray portion.

3. The hairpin winding motor of claim 1, wherein the cooling oil injection tube further includes an auxiliary nozzle formed on the cooling oil injection tube and directed toward the inner coil to spray the supplied cooling oil directly to the inner coil.

4. The hairpin winding motor of claim 1, wherein the rotor plate includes:
a circular body portion having a center penetrated by the rotor shaft;
a spray portion protruding outward from an outer surface of the circular body portion, formed at a radially center of the circular body portion, and formed in a circumferential direction thereof;
a first spray groove formed in a radially inner surface of the spray portion, disposed adjacent to the outer surface of the circular body portion, and recessed radially outward;
a second spray groove formed in the radially inner surface of the spray portion, disposed to be spaced apart from the outer surface of the circular body portion, and recessed radially outward;
a spray hole formed in the second spray groove and formed through the radially inner surface and an outer surface of the spray portion;
a partition wall formed to separate the first spray groove and the second spray groove; and
connection grooves formed in the partition wall so that the cooling oil distributed in the first spray groove moves to the second spray groove, and
wherein a spray surface configured to spray the cooling oil is formed on the outer surface of the circular body portion, and the spray surface is formed at a radially inner side of the spray portion.

5. The hairpin winding motor of claim 4, wherein the connection grooves are formed at predetermined distances in the circumferential direction and recessed radially inward, the connection grooves are formed adjacent to the spray hole, and a depth of the connection grooves is smaller than a depth of each of the first and second spray grooves.

6. The hairpin winding motor of claim 4, wherein the spray hole is disposed to be spaced apart from a position, at which the connection grooves are formed, by a first angle in a direction opposite to the rotation of the rotor plate.

7. The hairpin winding motor of claim 4, wherein the connection grooves are inclined at a second angle with respect to a rotation axis of the rotor plate in a rotation direction of the rotor plate.

8. The hairpin winding motor of claim 1, wherein the cooling oil injection tube is connected to a lubricating oil spray tube configured to inject lubricating oil into the winding motor, and the cooling oil is the lubricating oil.

9. The hairpin winding motor of claim 2, wherein the spray hole is provided as a plurality of spray holes disposed to be spaced apart from one another in the circumferential direction of the spray portion.

10. The hairpin winding motor of claim 3, wherein the auxiliary nozzle is provided as a plurality of auxiliary nozzles disposed to be spaced apart from one another in a longitudinal direction of the cooling oil injection tube.

11. A hairpin coil cooling structure for a hairpin winding motor including a stator having a plurality of slots formed through the stator in a circumferential direction thereof and each having a plurality of layers in a radial direction thereof, and a plurality of hairpin coils fastened to the slots and connected to one another to define a coil winding, the hairpin coil cooling structure comprising:
an oil injection tube configured to spray a cooling oil into the winding motor, and
a nozzle, which is provided at an end of the cooling oil injection tube to spray the cooling oil to an outer surface of the rotor plate, is disposed to be directed toward the outer surface of the rotor plate,
wherein the cooling oil sprayed to the outer surface of the rotor plate is scattered toward an inner coil, which is positioned at a radially inner side of the stator among the hairpin coils, by a rotation of the rotor plate.

12. The hairpin coil cooling structure of claim 11, further including:
a spray portion protruding outward from an outer surface of a circular body portion having a center penetrated by a rotor shaft, formed at a radially center of the circular body portion, and formed in a circumferential direction thereof;
a spray groove formed in a radially inner surface of the spray portion and recessed radially outward; and
a spray hole formed in the spray groove and formed through the radially inner surface and an outer surface of the spray portion, and
wherein a spray surface configured to spray the cooling oil is formed on the outer surface of the circular body portion, and the spray surface is formed at a radially inner side of the spray portion.

13. The hairpin coil cooling structure of claim 11, wherein the cooling oil injection tube further includes an auxiliary nozzle formed on the cooling oil injection tube and directed toward the inner coil to spray the supplied cooling oil directly to the inner coil.

14. The hairpin coil cooling structure of claim 11, further including:
a spray portion protruding outward from an outer surface of a circular body portion having a center penetrated by a rotor shaft, formed at a radially center of the circular body portion, and formed in a circumferential direction thereof;
a first spray groove formed in a radially inner surface of the spray portion, disposed adjacent to the outer surface of the circular body portion, and recessed radially outward;
a second spray groove formed in the radially inner surface of the spray portion, disposed to be spaced apart from the outer surface of the circular body portion, and recessed radially outward;
a spray hole formed in the second spray groove and formed through the radially inner surface and an outer surface of the spray portion;
a partition wall formed to separate the first spray groove and the second spray groove; and
connection grooves formed in the partition wall so that the cooling oil distributed in the first spray groove moves to the second spray groove, and
wherein a spray surface configured to spray the cooling oil is formed on the outer surface of the circular body portion, and the spray surface is formed at a radially inner side of the spray portion.

15. The hairpin coil cooling structure of claim 14, wherein the connection grooves are formed at predetermined distances in the circumferential direction and recessed radially inward, the connection grooves are formed adjacent to the spray hole, and a depth of the connection grooves is smaller than a depth of each of the first and second spray grooves.

16. The hairpin coil cooling structure of claim 14, wherein the spray hole is disposed to be spaced apart from a position, at which the connection grooves are formed, by a first angle in a direction opposite to the rotation of the rotor plate.

17. The hairpin coil cooling structure of claim 14, wherein the connection grooves are inclined at a second angle with respect to a rotation axis of the rotor plate in a rotation direction of the rotor plate.

18. The hairpin coil cooling structure of claim 11, wherein the cooling oil injection tube is connected to a lubricating oil spray tube configured to inject lubricating oil into the winding motor, and the cooling oil is the lubricating oil.

19. The hairpin coil cooling structure of claim 12, wherein the spray hole is provided as a plurality of spray holes disposed to be spaced apart from one another in the circumferential direction of the spray portion.

20. The hairpin coil cooling structure of claim 13, wherein the auxiliary nozzle is provided as a plurality of auxiliary nozzles disposed to be spaced apart from one another in a longitudinal direction of the cooling oil injection tube.
